(19) United States
(12) Patent Application Publication
(10) Pub. No.: US 2022/0297684 A1
(43) Pub. Date: Sep. 22, 2022

(54) DRIVING SUPPORT APPARATUS, DRIVING SUPPORT METHOD, AND COMPUTER-READABLE MEDIUM

(71) Applicant: Panasonic Intellectual Property Management Co., Ltd., Osaka (JP)

(72) Inventors: Shingo KAWAHARA, KANAGAWA KEN (JP); Atsushi SEKI, KANAGAWA KEN (JP)

(73) Assignee: Panasonic Intellectual Property Management Co., Ltd., Osaka (JP)

(21) Appl. No.: 17/684,847

(22) Filed: Mar. 2, 2022

(30) Foreign Application Priority Data
Mar. 17, 2021 (JP) 2021-044032

(51) Int. Cl. B60W 30/09

(52) U.S. Cl. CPC B60W 30/09; B60W 2540/10; B60W 2720/10; B60W 2520/10; B60W 2554/802

(57) ABSTRACT

A driving support apparatus includes a memory, and a hardware processor coupled to the memory. The hardware processor is configured to detect an obstacle; control a driving force of the vehicle to perform collision avoidance control for the obstacle; calculate a reduction amount of the driving force when the vehicle has climbed over a target object, in accordance with a distance between the vehicle and the obstacle when the vehicle has climbed over the target object; and control the collision avoidance control so as to gradually increase the driving force from an initial driving force being a driving force smaller than required driving force determined from an accelerator position of an accelerator pedal until a vehicle speed of the vehicle reaches a set vehicle speed, and so as to reduce the driving force by the reduction amount when the vehicle speed of the vehicle reaches the set vehicle speed.

### CROSS-REFERENCE TO RELATED APPLICATIONS

This application is based upon and claims the benefit of priority from Japanese Patent Application No. 2021-044032, filed on Mar. 17, 2021, the entire contents of which are incorporated herein by reference.

### FIELD

The present disclosure relates to a driving support apparatus, a driving support method, and a computer-readable medium.

### BACKGROUND

Collision avoidance control avoiding collision with obstacles around a vehicle has conventionally been known. In the collision avoidance control, a technique to adjust driving force in accordance with a road surface condition is disclosed.

A technique limiting acceleration of a vehicle when an obstacle is detected, when there is a step between the obstacle and the vehicle, gradually loosening the acceleration limitation to climb over the step, and again executing the acceleration limitation after climbing over is disclosed, for example (See Japanese Patent Application Laid-open No. 2014-91351, for example).

However, in the conventional technique, depending on a distance to the obstacle after climbing over a target object such as a step, the acceleration limitation may be too strict to sufficiently approach the obstacle, or the acceleration limitation may be so loose that it leads to contact with the obstacle. Thus, the conventional technique may have difficulty in performing favorable vehicle travel support.

A problem to be solved by the present disclosure is to provide a driving support apparatus and a driving support method capable of performing favorable vehicle travel support.

### SUMMARY

A driving support apparatus according to the present disclosure includes a memory, and a hardware processor coupled to the memory. The hardware processor is configured to detect an obstacle in a travel direction of a vehicle; control a driving force of the vehicle to perform collision avoidance control for the obstacle when the obstacle is detected; calculate a reduction amount of the driving force when the vehicle has climbed over a target object present between the vehicle on which the collision avoidance control has been started and the obstacle, in accordance with a distance between the vehicle and the obstacle when the vehicle has climbed over the target object; and control the collision avoidance control so as to gradually increase the driving force from an initial driving force being a driving force smaller than required driving force determined from an accelerator position of an accelerator pedal operated by a driver until a vehicle speed of the vehicle reaches a set vehicle speed, and so as to reduce the driving force by the reduction amount when the vehicle speed of the vehicle reaches the set vehicle speed, when the vehicle climbes over the target object.

### BRIEF DESCRIPTION OF THE DRAWINGS

FIG. 1 is a schematic diagram of an example of a vehicle in which a driving support apparatus of the present embodiment is installed;

FIG. 2 is a block diagram of a functional configuration of the vehicle;

FIG. 3 is a hardware configuration diagram;

FIG. 4A is an illustrative diagram of an example of collision avoidance control;

FIG. 4B is an illustrative diagram of the example of the collision avoidance control;

FIG. 5 is an illustrative diagram of a case in which a target object is present between the vehicle and an obstacle;

FIG. 6A is an illustrative diagram of an example of the collision avoidance control;

FIG. 6B is an illustrative diagram of the example of the collision avoidance control;

FIG. 6C is an illustrative diagram of the example of the collision avoidance control;

FIG. 7A is an illustrative diagram of an example of climbing over the target object;

FIG. 7B is an illustrative diagram of the example of climbing over the target object;

FIG. 7C is an illustrative diagram of the example of climbing over the target object;

FIG. 8A is an illustrative diagram of a distance between the vehicle and the obstacle;

FIG. 8B is an illustrative diagram of an example of the collision avoidance control;

FIG. 9 is an illustrative diagram of a case in which a road surface has a gradient;

FIG. 10A is an illustrative diagram of an example of the collision avoidance control;

FIG. 10B is an illustrative diagram of the example of the collision avoidance control; and

FIG. 11 is a flowchart of an example of information processing.

### DETAILED DESCRIPTION

The following describes an embodiment of a driving support apparatus and a driving support method according to the present disclosure with reference to the accompanying drawings.

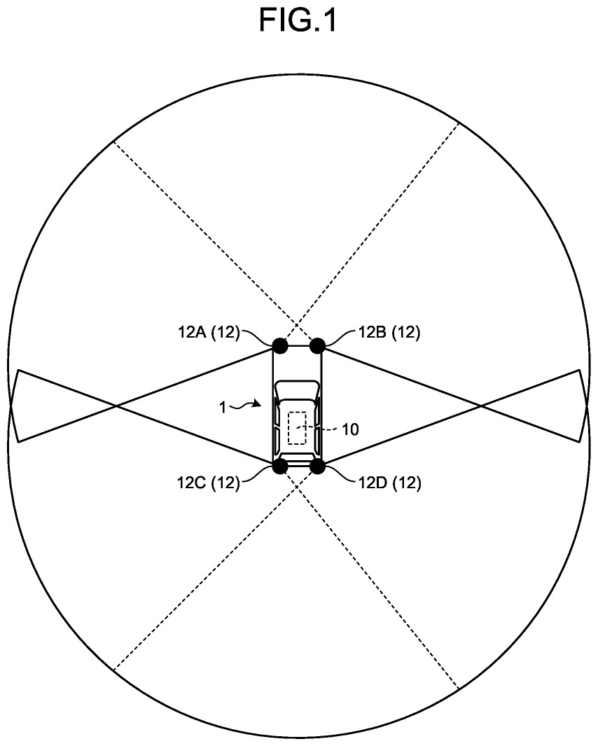

FIG. 1 is a schematic diagram of an example of a vehicle 1 in which a driving support apparatus 10 of the present embodiment is installed.

The driving support apparatus 10 is an information processing apparatus performing collision avoidance control for an obstacle using detection result information around the vehicle 1. The present embodiment describes a mode in which the driving support apparatus 10 is installed in the vehicle 1 as an example.

The vehicle 1 is provided with a plurality of sensors 12. The sensors 12 are sensors detecting an object around the vehicle 1. In the present embodiment, the sensors 12 have a detection distance of a few centimeters to a few meters, for example, and can detect the presence or absence of the object at a relatively short distance and a distance to the object. The present embodiment describes a mode in which the sensors 12 are ultrasonic sensors as an example. The ultrasonic sensors each have an emission function emitting an ultrasonic wave of 20 kHz to 100 kHz as a transmission wave and a reception function receiving the ultrasonic wave reflected by the object as a reflected wave.

In the present embodiment, the vehicle 1 includes a sensor 12A to a sensor 12D as the sensors 12. The sensor 12A and the sensor 12B are provided at one of a full-length direction orthogonal to a vehicle width direction of the vehicle 1. Specifically, the sensor 12A and the sensor 12B are provided in a front bumper of the vehicle 1, for example. The sensor 12C and the sensor 12D are provided at the other of the full-length direction of the vehicle 1. The sensor 12C and the sensor 12D are provided in a rear bumper of the vehicle 1, for example.

The number and the arrangement of the sensors 12 provided in the vehicle 1 are not limited to the above mode. One or three or more sensors 12 may be provided at a front part of the vehicle 1, one or three or more sensors 12 may be provided at a rear part of the vehicle 1, and one or more sensors 12 may be provided at a side part of the vehicle 1, for example.

Each of the sensor 12A to the sensor 12D detects an object in a detection range of each of them and outputs detection information of the object to the driving support apparatus 10.

The following describes a functional configuration of the vehicle 1 in detail.

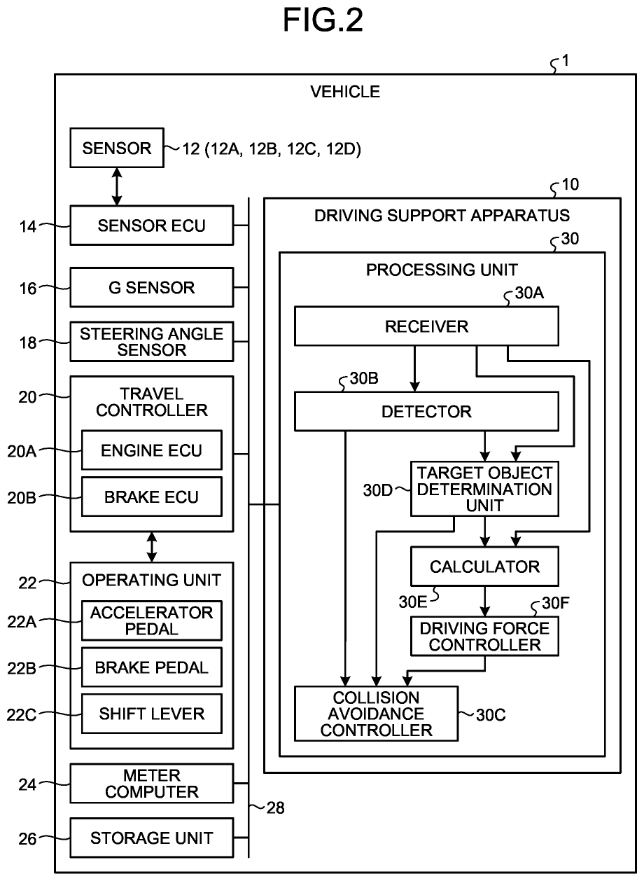

FIG. 2 is a block diagram of the functional configuration of the vehicle 1. The vehicle 1 includes the sensors 12, a sensor engine control unit (ECU) 14, a G sensor 16, a steering angle sensor 18, a travel controller 20, an operating unit 22, a meter computer 24, a storage unit 26, and the driving support apparatus 10.

The sensor ECU 14, the G sensor 16, the steering angle sensor 18, the travel controller 20, the meter computer 24, the storage unit 26, and the driving support apparatus 10 are connected to each other in a communicable manner via a bus 29. The travel controller 20 is connected to the operating unit 22 and the driving support apparatus 10 in a communicable manner.

The sensor ECU 14 is connected to the sensors 12 in a communicable manner. The sensor ECU 14 receives the detection information of the object from the sensors 12. The sensor ECU 14 calculates the distance to the object from the detection information and outputs the detection result information including information on the calculated distance to the driving support apparatus 10. The distance to the object may be referred to as a target distance.

The sensor ECU 14 measures the time from when the ultrasonic wave emitted from the sensor 12 is reflected by the object to when the reflected wave returns to measure the distance to the object. When a detection angle of the sensor 12 is a wide range such as 90°, a direction of the object is not determined by the detection information by a single sensor 12 alone. Thus, the sensor ECU 14 identifies the position of the object using information on the distance to the object detected by the sensors 12. The position of the object is represented by a distance and a direction from the vehicle 1, for example. The sensor ECU 14 can also determine a shape about whether the detected object has a shape like a wall or a shape like a utility pole using the detection information by the sensors 12.

In the present embodiment, the sensor ECU 14 outputs the detection result information including object information of the object detected by the sensors 12 and distance information representing the distance to the object to the driving support apparatus 10.

The object is a thing detectable by the sensors 12. That is to say, in the present embodiment, the object is a thing reflecting the ultrasonic wave emitted from the sensors 12 and producing the reflected wave. In the present embodiment, the object includes an obstacle and a target object.

The obstacle is an object difficult for the vehicle 1 to climb over and then travel. The obstacle is an object with which the vehicle 1 avoids contact. Examples of the obstacle include, but are not limited to, a wall and a utility pole.

The target object is an object that the vehicle 1 can climb over and then travel. Examples of the target object include, but are not limited to, a step, a curb, and a flap.

The object information includes at least one of obstacle information representing that the detected object is the obstacle and target object information representing that the detected object is the target object.

The sensor ECU 14 stores therein in advance obstacle characteristic information representing the characteristics such as the shape and the height of the obstacle. The sensor ECU 14 stores therein in advance target object characteristic information representing the characteristics such as the shape and the height of the target object such as a step in accordance with the vehicle height of the vehicle 1 or the like. The sensor ECU 14 searches the obstacle characteristic information or the target object characteristic information corresponding to the shape information of the object identified by the detection information by the sensors 12. Through such processing, the sensor ECU 14 may identify whether the object detected by the sensors 12 is the obstacle or the target object.

The sensor ECU 14 may output the detection result information including the object information of the object and the distance information representing the distance to the object to the driving support apparatus 10. At least part of the processing by the sensor ECU 14 may be executed by the driving support apparatus 10 or the sensors 12.

The G sensor 16 measures the acceleration of the vehicle 1 and outputs a measurement result to the driving support apparatus 10. The present embodiment describes a mode in which the G sensor 16 outputs the measurement result of each of the acceleration of the vehicle 1 in a front-and-rear direction and the acceleration of the vehicle 1 in an up-and-down direction to the driving support apparatus 10 as an example. The front-and-rear direction matches the full-length direction orthogonal to the vehicle width direction of the vehicle 1. The up-and-down direction of the vehicle 1 is a direction orthogonal to both the vehicle width direction and the full-length direction of the vehicle 1. When a plane formed by the vehicle width direction and the full-length direction of the vehicle 1 matches a horizontal plane, the up-and-down direction of the vehicle 1 matches a vertical direction, for example.

The G sensor 16 outputs a total value of acceleration calculated from a wheel speed of the vehicle 1 and gravity acceleration by the inclination of the vehicle 1 as the inclination of a road surface on which the vehicle 1 travels as measurement result information of the acceleration of the vehicle 1 in the front-and-rear direction to the driving support apparatus 10.

The steering angle sensor 18 detects a steering angle of a steering wheel provided in the vehicle 1 and outputs the steering angle as steering angle information to the driving support apparatus 10.

The travel controller 20 is an ECU controlling the travel of the vehicle 1. The travel controller 20 includes an engine ECU 20A and a brake ECU 20B.

The engine ECU 20A executes control of drive apparatuses of the vehicle 1 such as an engine and a motor and control of transmission apparatuses of the vehicle 1 such as a transmission. The engine ECU 20A performs control of a throttle actuator and a transmission gear provided in the vehicle 1, for example. The engine ECU 20A performs control of an accelerator actuator transmitting information to a driver through driving of an accelerator pedal 22A.

The engine ECU 20A is connected to the operating unit 22 in a communicable manner. The engine ECU 20A transmits operation information by a user received from the operating unit 22 to the driving support apparatus 10.

The operating unit 22 is operated by the driver as the user. The operating unit 22 includes the accelerator pedal 22A, a brake pedal 22B, and a shift lever 22C, for example. The operating unit 22 installed in the vehicle 1 is not limited to these examples.

The engine ECU 20A outputs the operation information including accelerator pedal operation information of the accelerator pedal 22A and shift position information of the shift lever 22C to the driving support apparatus 10.

The accelerator pedal operation information is information representing an operating state of the accelerator pedal 22A and is information representing an accelerator position of the accelerator pedal 22A. The accelerator position is detected by an opening rate sensor connected to the accelerator pedal 22A, for example.

The shift position information is information representing the position of the shift lever 22C. The shift position information is information representing a shift position such as parking, reversing, neutral, or normal traveling, for example. The shift position information may further include information representing a travel mode and a control state of the vehicle 1. The shift position information may include information on the travel mode such as a sport mode or a snow mode and the state of use of cruise control, for example.

The brake ECU 20B performs control of a braking system of the vehicle 1. The brake ECU 20B performs control of a brake actuator actuating a hydraulic brake apparatus disposed in each of wheels of the vehicle 1, for example. The brake ECU 20B performs control of the brake actuator in order to transmit information to the driver through driving of the brake pedal 22B. The brake ECU 20B outputs operation information of the brake pedal 22B and information on the wheel speed of the vehicle 1 to the driving support apparatus 10. The information on the wheel speed is a signal from a wheel speed sensor provided in each of the wheels of the vehicle 1, for example. The wheel speed is a rotational speed of the wheels of the vehicle 1.

The meter computer 24 is provided with an information notification function for the driver. The information notification function includes a display function displaying information, sound output function outputting a sound representing information, and the like. The display function is a combination meter apparatus providing notification by display to the driver, for example. The sound output function is a notification sound generator providing notification by a buzzer or a sound, for example.

The storage unit 26 stores therein various kinds of data. The storage unit 26 is a semiconductor memory element such as a random access memory (RAM) or a flash memory, a hard disk, or an optical disc, for example. The storage unit 26 may be a storage medium. Specifically, the storage medium may be obtained by downloading a computer program or various kinds of information via a local area network (LAN), the Internet, or the like and storing it therein or temporarily storing it therein. The storage unit 26 may include a plurality of storage media.

The following describes the driving support apparatus 10 in detail.

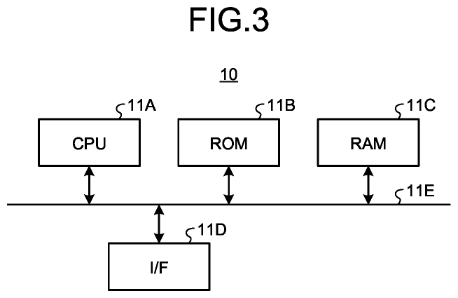

FIG. 3 is an example of a hardware configuration diagram of the driving support apparatus 10.

The driving support apparatus 10, in which a central processing unit (CPU) 11A, a read only memory (ROM) 11B, a RAM 11C, an interface (I/F) 11D, and the like are connected to each other via a bus 11E, has a hardware configuration using a normal computer.

The CPU 11A is a processor controlling the driving support apparatus 10 of the present embodiment. The ROM 11B stores therein a computer program implementing various kinds of processing by the CPU 11A and the like. The RAM 11C stores therein data required for the various kinds of processing by the CPU 11A. The I/F 11D is an interface for transmitting and receiving data.

The computer program for executing information processing to be executed by the driving support apparatus 10 of the present embodiment is embedded in the ROM 11B or the like in advance to be provided. The computer program to be executed by the driving support apparatus 10 of the present embodiment may be recorded and provided in a computer-readable recording medium such as a compact disc read only memory (CD-ROM), a flexible disk (FD), a compact disc recordable (CD-R), and a digital versatile disc (DVD) as a file of a format installable to or a format executable by the driving support apparatus 10.

Referring back to FIG. 2, the description is continued.

The driving support apparatus 10 includes a processing unit 30. The processing unit 30 executes various kinds of information processing. The CPU 11A reads the computer program from the ROM 11B onto the RAM 11C and executes it, whereby functional units of the processing unit 30 described below are implemented on the computer, for example. The computer program is a computer program installed in an intelligent clarence sonar (ICS) application, for example, which is not limiting. The ICS application is an example of software operating on the driving support apparatus 10.

The processing unit 30 includes a receiver 30A, a detector 30B, a collision avoidance controller 30C, a target object determination unit 30D, a calculator 30E, and a driving force controller 30F. Part or the whole of the receiver 30A, the detector 30B, the collision avoidance controller 30C, the target object determination unit 30D, the calculator 30E, and the driving force controller 30F may be implemented by causing a processor such as the CPU 11A to execute a computer program, that is, by software, be implemented by hardware such as an integrated circuit (IC), or be implemented by using software and hardware in combination, for example. At least one of the receiver 30A, the detector 30B, the collision avoidance controller 30C, the target object determination unit 30D, the calculator 30E, and the driving force controller 30F may be installed in an external information processing apparatus connected to the driving support apparatus 10 in a communicable manner via a network or the like.

The receiver 30A receives various kinds of information from each of the sensor ECU 14, the G sensor 16, the steering angle sensor 18, the engine ECU 20A, and the brake ECU 20B.

In the present embodiment, the receiver 30A receives the detection result information from the sensor ECU 14. The receiver 30A receives the measurement result information of the acceleration of the vehicle 1 from the G sensor 16. The receiver 30A receives the steering angle information from the steering angle sensor 18. The receiver 30A receives the operation information including the accelerator pedal operation information of the accelerator pedal 22A and the shift position information of the shift lever 22C from the engine ECU 20A. The receiver 30A receives the operation information of the brake pedal 22B and the information on the wheel speed of the vehicle 1 from the brake ECU 20B.

The detector 30B detects the obstacle in a travel direction of the vehicle 1. The detector 30B identifies the travel direction of the vehicle 1 from the direction of the acceleration detected by the G sensor 16, for example. The detector 30B determines whether the object information included in the detection result information received from the sensor ECU 14 by the receiver 30A includes the obstacle information indicating the obstacle present in the identified travel direction, for example. When the object information includes the obstacle information representing that the detected object is the obstacle, the detector 30B detects the obstacle in the travel direction of the vehicle 1. That is to say, the detector 30B detects that the obstacle is present in the travel direction of the vehicle 1.

The collision avoidance controller 30C, when the obstacle is detected, controls driving force of the vehicle 1 to perform collision avoidance control for the obstacle. The collision avoidance control is control to limit the driving force of the vehicle 1 to driving force smaller than required driving force determined from the accelerator position of the accelerator pedal 22A operated by the driver.

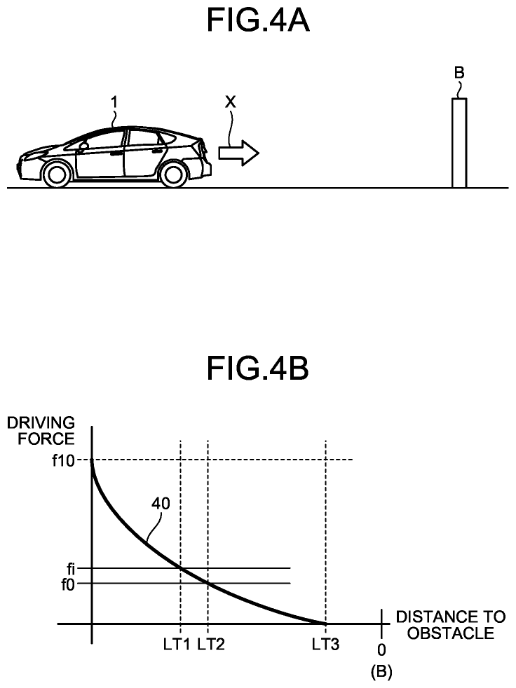

FIG. 4A and FIG. 4B are illustrative diagrams of an example of the collision avoidance control. FIG. 4A is an illustrative diagram of an example of a positional relation between the vehicle 1 and an obstacle B. Assumed is a situation in which the vehicle 1 is traveling in a travel direction X, and the obstacle B is present downstream in this travel direction X, for example. When the detector 30B of the vehicle 1 detects the obstacle B, the collision avoidance controller 30C executes the collision avoidance control for the obstacle B. The collision avoidance controller 30C controls the driving force of the vehicle 1 to execute the collision avoidance control.

FIG. 4B is an illustrative diagram of an example of the collision avoidance control by the collision avoidance controller 30C. In FIG. 4B, the horizontal axis indicates a distance from the vehicle 1 to the obstacle B. In FIG. 4B, the spot B is the position of the obstacle B, that is, a spot at which the distance to the obstacle B is zero. In FIG. 4B, the vertical axis indicates the driving force of the vehicle 1.

When the obstacle B is detected, the collision avoidance controller 30C controls the driving force of the vehicle 1 such that the driving force becomes smaller than required driving force f10 determined from the accelerator position of the accelerator pedal 22A operated by the driver, and controls the travel controller 20 such that the driving force becomes smaller as the distance to the obstacle B becomes shorter.

As represented by a chart 40 in FIG. 4B, the collision avoidance controller 30C controls the travel controller 20 such that the driving force gradually reduces toward a driving force of zero as it approaches the obstacle B, and the driving force becomes zero at a point in time of a preset distance from the obstacle B, for example. Specifically, the collision avoidance controller 30C calculates the driving force being less than the required driving force f10 and being lower as it approaches the obstacle B in accordance with the distance between the vehicle 1 and the obstacle B. The collision avoidance controller 30C successively outputs the driving force calculated in accordance with the distance as limited required driving force, which is required driving force that has been limited, to the travel controller 20. The engine ECU 20A and the brake ECU 20B included in the travel controller 20 control the vehicle 1 such that the vehicle 1 is driven by the received limited required driving force. Thus, by the collision avoidance control by the collision avoidance controller 30C, the vehicle 1 is driven by the driving force of the limited required driving force, and collision with the obstacle B is avoided.

Referring back to FIG. 2, the description is continued. The target object may be present between the vehicle 1 and the obstacle B. As described above, the target object is a thing that the vehicle 1 can climb over such as a step, a curb, or a flap.

The target object determination unit 30D determines whether the target object is present between the vehicle 1 on which the collision avoidance control has been started by the collision avoidance controller 30C and the obstacle B.

The target object determination unit 30D determines whether the object information included in the detection result information received from the sensor ECU 14 by the receiver 30A includes the target object information, for example. When the object information includes the target object information representing that the detected object is the target object such as a step, the target object determination unit 30D determines that the target object is present between the vehicle 1 and the obstacle B. The target object determination unit 30D is not limited to the mode in which the target object is determined based on the detection result information by the sensors 12.

The target object determination unit 30D may determine the presence of the target object by determining an abnormality of the vehicle speed with respect to the driving force of the vehicle 1, for example. The abnormality of the vehicle speed with respect to the driving force is a case in which an estimated vehicle speed for the driving force produced by performing an accelerator operation on the accelerator pedal 22A by the driver is not produced in the vehicle 1. The vehicle speed is the speed of the vehicle 1.

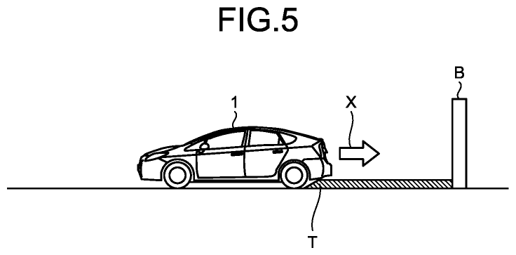

FIG. 5 is an illustrative diagram of an example of a case in which a target object T is present between the vehicle 1 and the obstacle B. When the driver presses the accelerator pedal 22A with the obstacle B detected, for example, even in a state in which the driving force of the vehicle 1 is limited by the collision avoidance control, the vehicle 1 must be accelerated in accordance with the limited required driving force. However, when the wheel is in contact with a step as the target object T illustrated in FIG. 5, for example, the vehicle 1 may be in a stopped state or a state in which a certain vehicle speed is not reached. In such a case, the target object determination unit 30D may determine that the target object T is present between the vehicle 1 and the obstacle B.

By the way, the driver may want to stop the vehicle 1 a little more closely to the obstacle B. In such a case, when the collision avoidance control limiting the driving force of the vehicle 1 in the travel direction X is performed, the driving force required for the travel of the vehicle 1 cannot necessarily be obtained by the influence of the target object T such as the step.

Given this, the collision avoidance controller 30C, when the vehicle 1 climbs over the target object T, gradually increases the driving force from the initial driving force as the driving force smaller than the required driving force f10 until the vehicle speed of the vehicle 1 reaches a set vehicle speed. The collision avoidance controller 30C then executes the collision avoidance control reducing the driving force when the vehicle speed of the vehicle 1 reaches the set vehicle speed.

For the set vehicle speed, a minimum vehicle speed required for the vehicle 1 to climb over the target object T may be set in advance, for example. The set vehicle speed may be able to be changed as appropriate in accordance with an operational instruction via the meter computer 24 or the like by the user or the like.

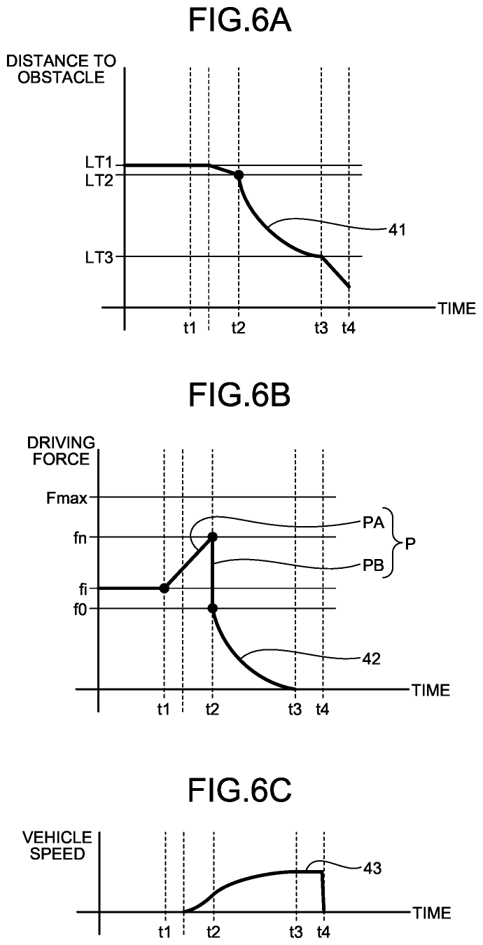

FIG. 6A to FIG. 6C are illustrative diagrams of an example of the collision avoidance control when the target object T is present between the vehicle 1 and the obstacle B.

FIG. 6A is an illustrative diagram of a relation between time and the distance to the obstacle B when climbing over the target object T. In FIG. 6A, the horizontal axis represents time, whereas the vertical axis represents the distance from the vehicle 1 to the obstacle B. FIG. 6B is an illustrative diagram of an example of the driving force of the vehicle 1 when the vehicle 1 climbs over the target object T. In FIG. 6B, the horizontal axis represents time, whereas the vertical axis represents the driving force. FIG. 6C is an illustrative diagram of a relation between time and the vehicle speed. In FIG. 6C, the horizontal axis represents time, whereas the vertical axis represents the vehicle speed of the vehicle 1.

When the obstacle B is detected, the collision avoidance controller 30C controls the driving force of the vehicle 1 such that the driving force becomes smaller than the required driving force f10 determined from the accelerator position of the accelerator pedal 22A operated by the driver, and controls the travel controller 20 such that the driving force becomes smaller as the distance to the obstacle B becomes shorter.

Now assumed is a case in which the target object T is present between the vehicle 1 and the obstacle B. It is assumed that at a point in time of a timing t1, a wheel downstream in the travel direction of the vehicle 1 has reached the target object T, for example. Even when the driver presses the accelerator pedal 22A at this point in time of the timing t1, the driving force of the vehicle 1 is limited to initial driving force fi.

The initial driving force fi is the driving force corresponding to the distance to the obstacle B at the time of controlling the driving force when the target object T is not present between the vehicle 1 and the obstacle B, for example. Specifically, the initial driving force fi is the driving force corresponding to the distance to the obstacle B when control of the driving force represented by the chart 40 in FIG. 4B is performed. The initial driving force fi is only required to be the driving force smaller than the required driving force f10 determined from the accelerator position of the accelerator pedal 22A operated by the driver and is not limited to the driving force represented by the chart 40.

Referring back to FIG. 6A to FIG. 6C, the description is continued. The driving force of the vehicle 1 is limited to the initial driving force fi, and thus the vehicle 1 cannot climb over the target object T such as a step. Given this, as illustrated in a chart 42 in FIG. 6B and a chart 43 in FIG. 6C, the collision avoidance controller 30C, when the vehicle 1 climbs over the target object T, gradually increases the driving force from the initial driving force fi until the vehicle speed of the vehicle 1 reaches the set vehicle speed. The “gradually increases the driving force” means that the driving force is increased with the lapse of time based on a detection result of the vehicle speed and does not prescribe an absolute value of an increasing rate of the driving force.

Specifically, as indicated from the timing t1 to a timing t2 in FIG. 6B, the collision avoidance controller 30C gradually releases the limitation of the driving force. The vehicle 1 for which the driving force has been gradually increased starts to climb up the target object T, and the vehicle speed starts to increase. The distance from the vehicle 1 to the obstacle B reduces from a distance LT1 to a distance LT2.

The collision avoidance controller 30C, when the vehicle speed of the vehicle 1 reaches the set vehicle speed, determines that it has climbed over the target object T and reduces the driving force. In the example illustrated in FIG. 6A to FIG. 6C, the collision avoidance controller 30C determines that the vehicle 1 has climbed over the target object T at a point in time of the timing t2. The collision avoidance controller 30C then reduces the driving force to driving force f0 corresponding to the distance LT2 from the vehicle 1 to the obstacle B at the point in time of the timing t2.

In a period from the timing t2 to a timing t3, the vehicle 1 accelerates until becoming the driving force controlled by the collision avoidance controller 30C. However, the distance to the obstacle B reduces, and thus the driving force and the acceleration of the vehicle 1 reduce. At a point in time of the timing t3, the driving force becomes zero, and acceleration of the vehicle 1 is forbidden. Thus, the vehicle 1 approaches the obstacle B at a constant speed. At a point in time of a timing t4, brake control is actuated, and the vehicle 1 stops before the distance to the obstacle B becomes a preset distance.

Thus, the chart 42 indicating a change in the driving force of the collision avoidance control has a peak P at a position corresponding to climbing over the target object T. The part of an increase area PA of this peak P corresponds to an increasing part gradually increasing the driving force from the initial driving force fi. The part of a reduction area PB of this peak P corresponds to a reducing part reducing the driving force in accordance with the distance to the obstacle B after the vehicle speed of the vehicle 1 reaches the set vehicle speed. The collision avoidance controller 30C adjusts the driving force such that the maximum driving force of the peak P is not more than maximum driving force fmax, which is less than the required driving force f10.

FIG. 6A to FIG. 6C assume and illustrate a case in which when reaching the target object T, the vehicle 1 is in a stopped state and describe a situation in which the accelerator pedal 22A has been operated in order to climbing over the target object T as an example. In this case, the set vehicle speed may be set in advance at a vehicle speed enabling the vehicle 1 to start to move and to climb over the target object T, for example. The set vehicle speed may be able to be reset as appropriate in accordance with the condition of the vehicle 1 or the like.

The collision avoidance controller 30C monitors the information on the wheel speed received by the receiver 30A to detect a change in the vehicle speed, which may be used for control of the driving force. Specifically, the collision avoidance controller 30C may calculate the vehicle speed of the vehicle 1 from the information on the wheel speed received from the brake ECU 20B by the receiver 30A.

FIG. 6B illustrates an example in which the driving force is continuously increased as an example of gradually increasing the driving force. However, the increase of the driving force, which may be a stepwise increase, is not limited to the continuous increase.

By control of the driving force by the collision avoidance controller 30C, the vehicle 1 can climb over the target object T and avoid collision with the obstacle B.

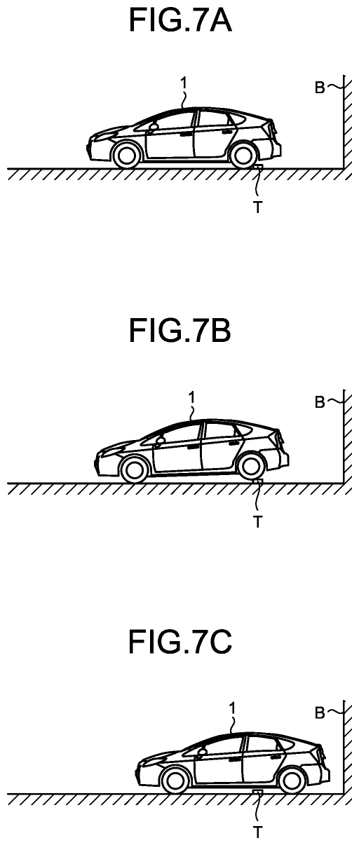

FIG. 7A to FIG. 7C are illustrative diagrams of an example of climbing over the target object T. By control of the driving force by the collision avoidance controller 30C, the vehicle 1, after a state of reaching the target object T illustrated in FIG. 7A, can climbing over the target object T and stop before the obstacle B as illustrated in FIG. 7B and FIG. 7C.

Depending on the distance between the vehicle 1 and the obstacle B after climbing over the target object T, the limitation of the driving force by the collision avoidance controller 30C is so strict that it may be difficult to stop sufficiently closely to the obstacle B. Alternatively, the limitation of the driving force is so loose that the vehicle 1 may make contact with the obstacle B.

Referring back to FIG. 2, the description is continued. Given these circumstances, in the present embodiment, the calculator 30E, in accordance with the distance between the vehicle 1 and the obstacle B when the vehicle 1 has climbed over the target object T present between the vehicle 1 on which the collision avoidance control has been started and the obstacle B, calculates a reduction amount of the driving force when the vehicle 1 has climbed over the target object T.

“When the vehicle 1 has climbed over the target object T” means a point in time when the vehicle 1 has climbed over the target object T. Specifically, “when the vehicle 1 has climbed over the target object T” means when, after the wheel of the vehicle 1 goes up onto the target object T, the wheel has left the top of the target object T.

Specifically, assumed is a case in which the vehicle 1 travels and climbes over a step as the target object T. In this case, when the vehicle 1 has climbed over the target object T means when, after the vehicle 1 travels to cause the wheel downstream in the travel direction of the vehicle 1 to go up onto the step as the target object T, a state in which the wheel has left the top of the step as the target object T is given. The state in which the wheel has left the top of the step as the target object T may vary depending on the shape of the target object T. When the target object T is a step, for example, when the state in which the wheel has left the target object T is reached means a state in which the wheel has passed a top part forming the step. When the target object T is a flap, when the state in which the wheel has left the target object T is given means when, after the wheel goes up onto the target object T, the wheel has gone down from the target object T.

The calculator 30E determines whether the vehicle 1 has climbed over the target object T. The determination whether the vehicle 1 has climbed over the target object T may be executed by the following method, for example.

The calculator 30E may determine that the vehicle 1 has climbed over the target object T when the vehicle speed of the vehicle 1 on which the collision avoidance control is being performed by the collision avoidance controller 30C reaches the set vehicle speed after the driving force is gradually increased from the initial driving force fi, for example.

The calculator 30E may determine that the vehicle 1 has climbed over the target object T by another method. The calculator 30E determines that the vehicle 1 has climbed over the target object T when a state in which the target object information representing the target object T is included in the detection result information received from the sensor ECU 14 has switched to a state in which it is not included, for example. The calculator 30E may determine that the vehicle 1 has climbed over the target object T when the acceleration of the vehicle 1 in the up-and-down direction and the front-and-rear direction measured by the G sensor 16 indicates a certain acceleration pattern caused when the vehicle 1 has climbed over the target object T, for example. The acceleration pattern when having climbed over the target object T may be stored in the storage unit 26 in advance in association with information representing the characteristics such as the shape of the target object T, for example. The calculator 30E searches the storage unit 26 for a pattern corresponding to the information representing the characteristics such as the shape of the target object T detected by the sensor ECU 14. The calculator 30E may determine that the vehicle 1 has climbed over the target object T when the pattern corresponding to the shape of the target object T matching the acceleration pattern caused when the vehicle 1 has climbed over the target object T is present in the storage unit 26.

The present embodiment describes a mode in which the calculator 30E determines that the vehicle 1 has climbed over the target object T when the vehicle speed of the vehicle 1 on which the collision avoidance control is being performed has reached the set vehicle speed after the driving force is gradually increased from the initial driving force fi, as an example.

The calculator 30E, in accordance with the distance between the vehicle 1 and the obstacle B when the vehicle 1 has climbed over the target object T, calculates the reduction amount of the driving force when the vehicle 1 has climbed over the target object T.

The reduction amount of the driving force when the vehicle 1 has climbed the target object T means the reduction amount of the driving force in the reduction area PB of the peak P included in the chart 42 illustrated in FIG. 6B. That is to say, the reduction amount is a reduction amount of the driving force reduced when the vehicle speed of the vehicle 1 has reached the set vehicle speed when climbing over the target object T.

The calculator 30E calculates the reduction amount being larger as the distance between the vehicle 1 and the obstacle B when the vehicle 1 has climbed over the target object T is shorter. The calculator 30E calculates the reduction amount being smaller as the distance between the vehicle 1 and the obstacle B when the vehicle 1 has climbed over the target object T is longer.

The calculator 30E may calculate the reduction amount using the distance between the vehicle 1 and the target object T included in the detection result information detected at the point in time when the vehicle 1 has climbed over the target object T.

The calculator 30E may estimate the reduction amount at a timing before the vehicle 1 climbes over the target object T.

In this case, the calculator 30E receives information such as the distance information to the target object T, the distance information to the obstacle B, the information on the wheel speed of the vehicle 1, the acceleration calculated from the wheel speed of the vehicle 1, and the inclination of the road surface on which the vehicle 1 travels from the receiver 30A. The calculator 30E may estimate the distance between the vehicle 1 and the obstacle B when the vehicle 1 has climbed over the target object T by a known method using these pieces of information.

The driving force controller 30F, when the vehicle 1 climbes over the target object T, gradually increases the driving force from the initial driving force fi as the driving force smaller than the required driving force f10 determined from the accelerator position of the accelerator pedal 22A operated by the driver until the vehicle speed of the vehicle 1 reaches the set vehicle speed. The driving force controller 30F, when the vehicle speed of the vehicle 1 reaches the set vehicle speed, controls the collision avoidance controller 30C so as to reduce the driving force by the reduction amount calculated by the calculator 30E.

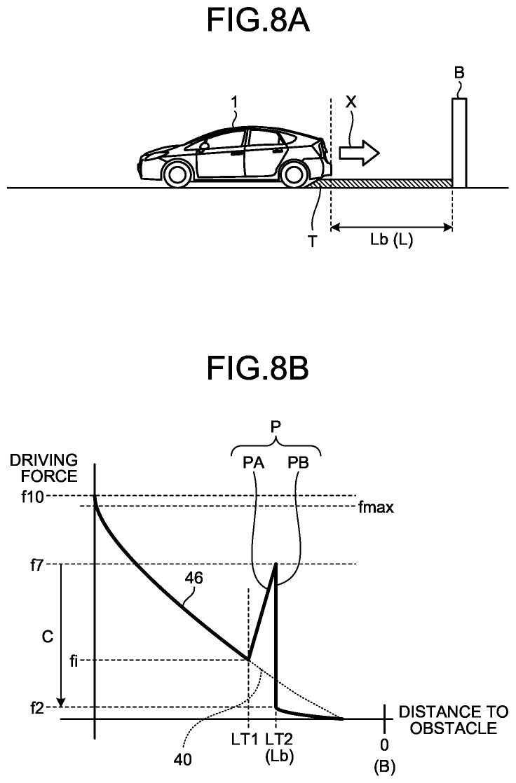

FIG. 8A and FIG. 8B are illustrative diagrams of an example of a case in which a distance L between the vehicle 1 and the obstacle B when the vehicle 1 has climbed the target object T is a distance Lb. In FIG. 8B, the horizontal axis indicates the distance from the vehicle 1 to the obstacle B. In FIG. 8B, the spot B is the position of the obstacle B, that is, a spot at which the distance to the obstacle B is zero. In FIG. 8B, LT1 is the distance between the vehicle 1 and the obstacle B when the vehicle 1 has reached the target object T. In FIG. 8B, LT2 is the distance Lb between the vehicle 1 and the obstacle when the vehicle 1 has climbed the target object T. In FIG. 8B, the vertical axis indicates the driving force of the vehicle 1.

In the same manner as the chart 42 described with reference to FIG. 6B, by control of the driving force by the collision avoidance controller 30C when the obstacle B is detected, a chart 46 indicating a change in the driving force of the collision avoidance control has the peak P at a position corresponding to climbing over the target object T.

In the present embodiment, the collision avoidance controller 30C, when the vehicle speed of the vehicle 1 reaches the set vehicle speed, reduces the driving force by a reduction amount C corresponding to the distance Lb calculated by the calculator 30E by the control of the driving force controller 30F. The reduction amount C is an amount being larger as the distance L is shorter.

Thus, as the distance L when the vehicle 1 has climbed over the target object T is shorter, the reduction amount C of the driving force of the reduction area PB of the peak P, that is, the reduction amount C of the driving force from the top of the peak P is larger. FIG. 8B illustrates an example in which the driving force is reduced by the reduction amount C from driving force f7 at a point in time of the top of the peak P to driving force f2.

Thus, as the distance L to the obstacle B when the vehicle 1 has climbed over the target object T is shorter, the driving force is inhibited more strongly or strictly. Consequently, the vehicle 1 after climbing over the target object T is inhibited from making contact with the obstacle B.

As the distance L when the vehicle 1 has climbed over the target object T is longer, the reduction amount C of the driving force of the reduction area PB of the peak P, that is, the reduction amount C of the driving force from the top of the peak P is smaller.

Thus, as the distance L to the obstacle B when the vehicle 1 has climbed over the target object T is longer, the driving force is inhibited more weakly or loosely. Consequently, the vehicle 1 after climbing over the target object T is inhibited from stopping at a position significantly separate from the obstacle B. That is to say, even when the distance L to the obstacle B when the vehicle 1 has climbed over the target object T is long, the vehicle 1 can stop sufficiently closely to the obstacle B. In addition, the driver can be inhibited from being given a sense of discomfort by the vehicle 1 stopping at the position significantly separate from the obstacle B.

The road surface on which the vehicle 1 travels to the obstacle B may have a gradient.

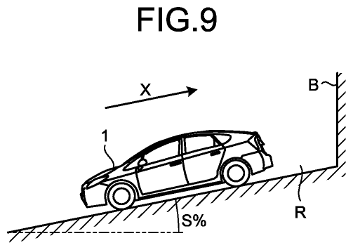

FIG. 9 is an illustrative diagram illustrating that a road surface R on which the vehicle 1 travels to the obstacle B has a gradient. When the road surface has a gradient, the limitation of the driving force by the collision avoidance controller 30C may be so strict that it may be difficult to stop sufficiently closely to the obstacle B. Alternatively, the limitation of the driving force may be so loose that it leads to contact with the obstacle B.

Given these circumstances, the calculator 30E may calculate the reduction amount C in accordance with the distance L between the vehicle 1 and the obstacle B when the vehicle 1 has climbed over the target object T and a gradient ratio of the road surface R on which the vehicle 1 travels to the obstacle B. The gradient ratio of the road surface R means the inclination of the vehicle body of the vehicle 1 with respect to a horizontal direction. FIG. 9 illustrates the gradient ratio as S %.

Referring back to FIG. 2, the description is continued. As described above, the measurement result information of the acceleration received from the G sensor 16 is a total value of the acceleration calculated from the wheel speed of the vehicle 1 and gravity acceleration by the inclination of the vehicle 1 as the inclination of the road surface R on which the vehicle 1 travels. Thus, the calculator 30E subtracts the acceleration calculated by the wheel speed from the measurement result information of the acceleration of the vehicle 1 in the front-and-rear direction measured by the G sensor 16 and can thereby calculate the inclination of the road surface R as the inclination of the vehicle 1. The calculator 30E may calculate the calculated inclination of the road surface R as the gradient ratio.

The calculator 30E calculates the reduction amount C being larger as the distance L is shorter and being smaller as the gradient ratio is larger. Specifically, the calculator 30E calculates the reduction amount C being larger as the distance L is shorter, for example. The calculator 30E may calculate the reduction amount C for use in control of the driving force by correcting the calculated reduction amount C to be a value being smaller as the gradient ratio is larger.

The collision avoidance controller 30C, when the vehicle speed of the vehicle 1 reaches the set vehicle speed when climbing over the target object T, reduces the driving force by the reduction amount C corresponding to the distance La and the gradient ratio calculated by the calculator 30E by the control of the driving force controller 30F.

Thus, the driving force of the vehicle 1 is inhibited more weakly or loosely as the distance to the obstacle B when the vehicle 1 has climbed over the target object T is longer and more weakly or loosely as the gradient ratio of the road surface R is larger. Consequently, the vehicle 1 after climbing over the target object T is inhibited from stopping at a position significantly separate from the obstacle B. That is to say, the vehicle 1 can be caused to stop sufficiently closely to the obstacle B. In addition, the driver can be inhibited from being given a sense of discomfort by the vehicle 1 stopping at the position significantly separate from the obstacle B.

FIG. 6A to FIG. 6C assume and illustrate a case in which when reaching the target object T, the vehicle 1 is in a stopped state. However, the vehicle speed when the vehicle 1 reaches the target object T is not necessarily zero. There may be a case in which the vehicle 1 climbes over the target object T while continuing movement, for example. That is to say, there are various cases such as a case in which the vehicle speed of the vehicle 1 when reaching the target object T is a high speed and a case in which it is a low speed.

Given these circumstances, the calculator 30E calculates an increase rate of the driving force from the initial driving force fi in accordance with the vehicle speed of the vehicle 1 when reaching the target object T. The increase rate of the driving force from the initial driving force fi means an increase rate of the driving force in the increase area PA of the peak P described above. The increase rate of the driving force may be either the increase rate of the driving force per unit time or the increase rate of the driving force per unit distance.

The calculator 30E derives the vehicle speed of the vehicle 1 when reaching the target object T.

The calculator 30E calculates the vehicle speed of the vehicle 1 when the vehicle 1 has reached the target object T from the information on the wheel speed received from the brake ECU 20B, for example. As to determination of the timing when the vehicle 1 has reached the target object T, it may be determined that the vehicle 1 has reached the target object T when the measurement result information received by the receiver 30A includes the target object information indicating that the object is the target object T and includes information indicating that the distance to the target object T is zero, for example. The calculator 30E may determine that the vehicle 1 has reached the target object T by another method. The calculator 30E may determine that the vehicle 1 has reached the target object T when the vehicle speed of the vehicle 1 on which the collision avoidance control is being performed has switched from a vehicle speed corresponding to the limited required driving force being output to the travel controller 20 to less than the vehicle speed, for example.

The calculator 30E may estimate the vehicle speed of the vehicle 1 when the vehicle 1 has reached the target object T before the vehicle 1 reaches the target object T. In this case, the calculator 30E receives information such as the distance information to the target object T, the distance information to the obstacle B, the information on the wheel speed of the vehicle 1, the acceleration calculated from the wheel speed of the vehicle 1, and the inclination of the road surface R on which the vehicle 1 travels from the receiver 30A. The calculator 30E may estimate the vehicle speed of the vehicle 1 when the vehicle 1 has reached the target object T by a known method using these pieces of information.

The calculator 30E calculates the increase rate from the initial driving force fi at the peak P in accordance with the vehicle speed of the vehicle 1 when the vehicle 1 has reached the target object T.

The calculator 30E calculates the increase rate being lower as the vehicle speed of the vehicle 1 when reaching the target object T is higher. That is to say, the calculator 30E calculates the increase rate being lower as the increase rate of the driving force in the increase area PA of the peak P as the vehicle speed of the vehicle 1 when reaching the target object T is higher.

The driving force controller 30F, when the vehicle 1 climbes over the target object T, controls the collision avoidance controller 30C so as to gradually increase the driving force from the initial driving force fi at the calculated increase rate until reaching the set vehicle speed.

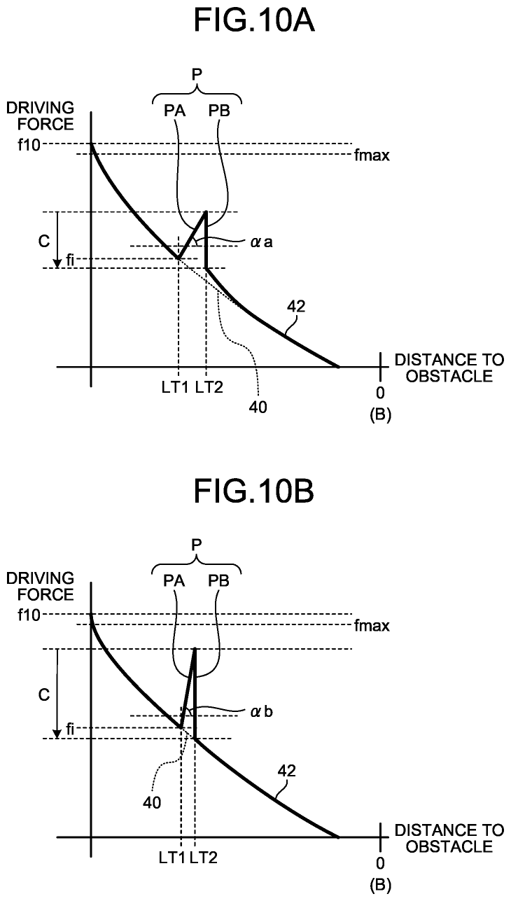

FIG. 10A is an illustrative diagram of an example of the collision avoidance control when the vehicle speed of the vehicle 1 when reaching the target object T is higher. In FIG. 10A, the horizontal axis indicates the distance from the vehicle 1 to the obstacle B. In FIG. 10A, the spot B is the position of the obstacle B, that is, a spot at which the distance to the obstacle B is zero. In FIG. 10A, LT1 is the distance L between the vehicle 1 and the obstacle B when the vehicle 1 has reached the target object T. In FIG. 10A, LT2 is the distance L between the vehicle 1 and the obstacle when the vehicle 1 has climbed over the target object T. In FIG. 10A, the vertical axis indicates the driving force of the vehicle 1.

In the same manner as the chart 42 described with reference to FIG. 6B, by control of the driving force by the collision avoidance controller 30C when the obstacle B is detected, a chart 46 indicating a change in the driving force of the collision avoidance control has the peak P at a position corresponding to climbing over the target object T.

When the vehicle 1 reaches the target object T, the collision avoidance controller 30C increases the driving force at an increase rate aa calculated by the calculator 30E by the control of the driving force controller 30F. The collision avoidance controller 30C, when the vehicle speed of the vehicle 1 reaches the set vehicle speed, reduces the driving force by the reduction amount C corresponding to the distance L calculated by the calculator 30E by the control of the driving force controller 30F.

Thus, as the vehicle speed of the vehicle 1 when reaching the target object T is higher, the driving force is increased more loosely or weakly. Thus, when the vehicle speed of the vehicle 1 when reaching the target object T is higher, the vehicle 1 can climb over the target object T by making use of the inertia of the vehicle itself. In addition, the difference with the inhibition of the driving force after climbing over the target object T is reduced, and sudden deceleration can be inhibited. Thus, a sense of discomfort of the driver can be reduced.

FIG. 10B is an illustrative diagram of an example of the collision avoidance control when the vehicle speed of the vehicle 1 when reaching the target object T is lower than that of the example illustrated in FIG. 10A. In FIG. 10B, the horizontal axis indicates the distance from the vehicle 1 to the obstacle B. In FIG. 10B, the spot B is the position of the obstacle B, that is, a spot at which the distance to the obstacle B is zero. In FIG. 10B, LT1 is the distance L between the vehicle 1 and the obstacle B when the vehicle 1 has reached the target object T. In FIG. 10B, LT2 is the distance L between the vehicle 1 and the obstacle when the vehicle 1 has climbed over the target object T. In FIG. 10B, the vertical axis indicates the driving force of the vehicle 1.

In the same manner as the chart 42 described with reference to FIG. 6B, by control of the driving force by the collision avoidance controller 30C when the obstacle B is detected, a chart 48 indicating a change in the driving force of the collision avoidance control has the peak P at a position corresponding to climbing over the target object T.

When the vehicle 1 reaches the target object T, the collision avoidance controller 30C increases the driving force at an increase rate ab calculated by the calculator 30E by the control of the driving force controller 30F. In this example, assumed is a case in which the vehicle 1 has reached the target object T at a vehicle speed slower than that of the example illustrated in FIG. 10A. In this case, the increase rate ab calculated by the calculator 30E is larger than the increase rate aa described with reference to FIG. 10A. The collision avoidance controller 30C, when the vehicle speed of the vehicle 1 reaches the set vehicle speed, reduces the driving force by the reduction amount C corresponding to the distance L calculated by the calculator 30E by the control of the driving force controller 30F.

Thus, as the vehicle speed of the vehicle 1 when reaching the target object T is lower, the driving force is increased more strongly or significantly. Thus, even when the vehicle speed of the vehicle 1 when reaching the target object T is lower, the vehicle 1 can climb over the target object T by making use of the inertia of the vehicle itself. In addition, the difference with the inhibition of the driving force after climbing over the target object T is reduced, and sudden deceleration can be inhibited. Thus, a sense of discomfort of the driver can be reduced.

The following describes an example of information processing executed by the driving support apparatus 10 of the present embodiment.

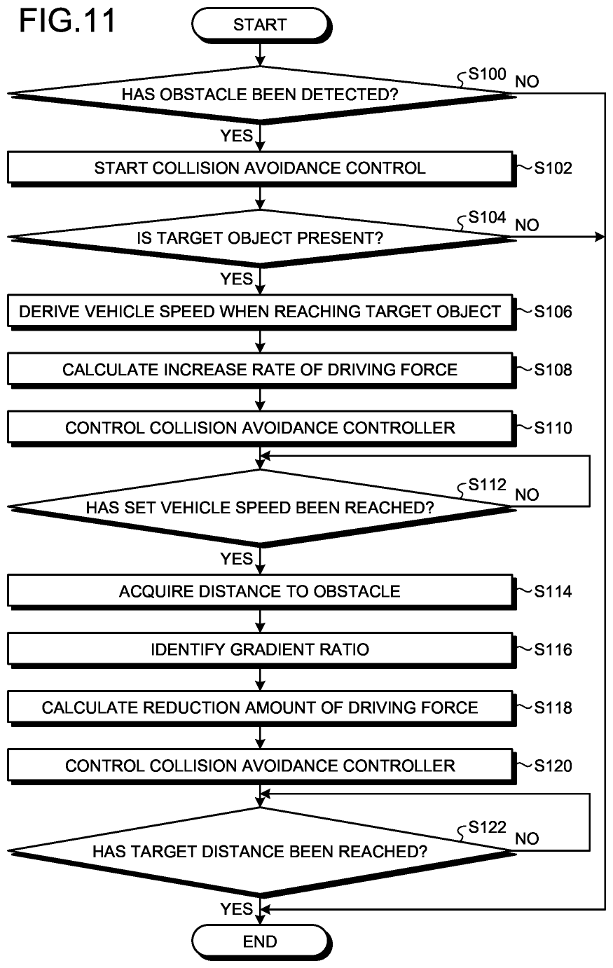

FIG. 11 is a flowchart of an example of the information processing executed by the driving support apparatus 10. It is assumed that the receiver 30A successively receives the various kinds of information described above from each of the sensor ECU 14, the G sensor 16, the steering angle sensor 18, the engine ECU 20A, and the brake ECU 20B.

The detector 30B determines whether the obstacle B has been detected in the travel direction of the vehicle 1 (Step S100). If making negative determination at Step S100 (No at Step S100), the present routine ends. If making affirmative determination at Step S100 (Yes at Step S100), the process advances to Step S102.

At Step S102, the collision avoidance controller 30C controls the driving force of the vehicle 1 to start the collision avoidance control avoiding collision with the obstacle B (Step S102).

Next, the target object determination unit 30D determines whether the target object T is present between the vehicle 1 and the obstacle B (Step S104). If it is determined that the target object T is not present (Step S104), the present routine ends. That is to say, when the target object T is not present, control of the driving force represented by the chart 40 in FIG. 4B is performed.

If it is determined that the target object T is present (Yes at Step S104), the process advances to Step S106. At Step S106, the calculator 30E derives the vehicle speed of the vehicle 1 when reaching the target object T (Step S106).

The calculator 30E calculates the increase rate of the driving force from the initial driving force fi in accordance with the vehicle speed derived at Step S106 (Step S108). The calculator 30E calculates the increase rate being lower as the vehicle speed derived at Step S106 is higher.

The driving force controller 30F, when the vehicle 1 climbes over the target object T, controls the collision avoidance controller 30C so as to gradually increase the driving force from the initial driving force fi at the increase rate calculated at Step S108 (Step S110).

The driving force controller 30F determines whether the vehicle speed of the vehicle 1 has reached the set vehicle speed (Step S112). The driving force controller 30F repeats negative determination (No at Step S112) until it determines that the vehicle speed of the vehicle 1 has reached the set vehicle speed. If the driving force controller 30F determines that the vehicle speed of the vehicle 1 has reached the set vehicle speed (Yes at Step S112), the process advances to Step S114.

At Step S114, the calculator 30E acquires the distance L between the vehicle 1 and the obstacle B (Step S114). As described above, in the present embodiment, the calculator 30E determines that the vehicle 1 has climbed over the target object T when the vehicle speed of the vehicle 1 has reached the set vehicle speed after the driving force is gradually increased from the initial driving force fi. Thus, when the affirmative determination is made at Step S114, the distance between the vehicle 1 and the obstacle B is acquired, whereby the calculator 30E acquires the distance L between the vehicle 1 and the obstacle B when the vehicle 1 has climbed over the target object T present between the vehicle 1 on which the collision avoidance control has been started and the obstacle B.

Next, the calculator 30E identifies the gradient ratio of the road surface R on which the vehicle 1 travels to the obstacle B (Step S116). The calculator 30E subtracts the acceleration calculated by the wheel speed from the measurement result information of the acceleration of the vehicle 1 in the front-and-rear direction measured by the G sensor 16 to calculate the inclination of the road surface R as the inclination of the vehicle 1, for example. The calculator 30E identifies the calculated inclination of the road surface R as the gradient ratio.

Next, the calculator 30E calculates the reduction amount C being larger as the distance L acquired at Step S114 is shorter and being smaller as the gradient ratio identified at Step S116 is larger (Step S118).

The driving force controller 30F, when the vehicle speed of the vehicle 1 has reached the set vehicle speed when climbing over the target object T, controls the collision avoidance controller 30C so as to reduce the driving force by the reduction amount C calculated at Step S118 (Step S120).

Next, the collision avoidance controller 30C determines whether the distance between the vehicle 1 and the obstacle B has reached a target distance (Step S122). The target distance may be set in advance. It may be able to be changed as appropriate by an operational instruction via the meter computer 24 or the like by the user. The collision avoidance controller 30C repeats negative determination (No at Step S122) until it makes affirmative determination (Yes at Step S122). If making affirmative determination at Step S122 (Yes at Step S122), the present routine ends.

As described in the foregoing, the driving support apparatus 10 of the present embodiment includes the detector 30B, the collision avoidance controller 30C, the calculator 30E, and the driving force controller 30F. The detector 30B detects the obstacle B in the travel direction of the vehicle 1. The collision avoidance controller 30C, when the obstacle B is detected, controls the driving force of the vehicle 1 to perform the collision avoidance control for the obstacle B. The calculator 30E, in accordance with the distance between the vehicle 1 and the obstacle B when the vehicle 1 has climbed over the target object T present between the vehicle 1 on which the collision avoidance control has been started and the obstacle B, calculates the reduction amount C of the driving force when the vehicle 1 has climbed over the target object T. The driving force controller 30F, when the vehicle 1 climbes over the target object T, controls the collision avoidance controller 30C so as to gradually increase the driving force from the initial driving force fi as the driving force smaller than the required driving force f10 determined from the accelerator position of the accelerator pedal 22A operated by the driver until the vehicle speed of the vehicle 1 reaches the set vehicle speed and, when the vehicle speed of the vehicle 1 reaches the set vehicle speed, to reduce the driving force by the reduction amount C.

Thus, the driving support apparatus 10 of the present embodiment, in accordance with the distance between the vehicle 1 and the obstacle B when the vehicle 1 has climbed over the target object T present between the vehicle 1 and the obstacle B, calculates the reduction amount C of the driving force when the vehicle 1 has climbed over the target object T. The driving support apparatus 10, when the vehicle 1 climbes over the target object T, when the vehicle speed of the vehicle 1 reaches the set vehicle speed, controls the collision avoidance controller 30C so as to reduce the driving force by the reduction amount C.

Thus, in accordance with the distance between the vehicle 1 and the obstacle B when the vehicle 1 has climbed over the target object T, the way of weakening or loosening the driving force when the vehicle 1 has climbed over the target object T is adjusted. Consequently, the vehicle 1 after climbing over the target object T is inhibited from stopping at a position significantly separate from the obstacle B. That is to say, it becomes possible to stop sufficiently closely to the obstacle B even when the distance to the obstacle B when the vehicle 1 has climbed over the target object T is long. In addition, the driver can be inhibited from being given a sense of discomfort by the vehicle 1 stopping at the position significantly separate from the obstacle B. In addition, the vehicle 1 after climbing over the target object T is inhibited from making contact with the obstacle B.

Consequently, the driving support apparatus 10 of the present embodiment can perform favorable vehicle travel support.

The present embodiment has described a mode in which the driving support apparatus 10 is installed in the vehicle 1 as an example. However, the driving support apparatus 10 may be installed outside the vehicle 1. The driving support apparatus 10 may be connected to various kinds of electronic devices provided in the vehicle 1 such as the sensor ECU 14, the G sensor 16, the steering angle sensor 18, the travel controller 20, the meter computer 24, and the storage unit 26 in a communicable manner. Thus, the driving support apparatus 10 may be installed in an information processing apparatus provided outside the vehicle 1. In this case, the information processing apparatus in which the driving support apparatus 10 is installed and the various kinds of electronic devices may be made communicable with each other via a network or the like.

The driving support apparatus, the driving support method, and a computer-readable medium according to the present disclosure can perform favorable vehicle travel support.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A driving support apparatus comprising:
a memory; and
a hardware processor coupled to the memory, the hardware processor being configured to:
detect an obstacle in a travel direction of a vehicle;
control a driving force of the vehicle to perform collision avoidance control for the obstacle when the obstacle is detected;
calculate a reduction amount of the driving force when the vehicle has climbed over a target object present between the vehicle on which the collision avoidance control has been started and the obstacle, in accordance with a distance between the vehicle and the obstacle when the vehicle has climbed over the target object; and
control the collision avoidance control so as to gradually increase the driving force from an initial driving force being a driving force smaller than required driving force determined from an accelerator position of an accelerator pedal operated by a driver until a vehicle speed of the vehicle reaches a set vehicle speed, and so as to reduce the driving force by the reduction amount when the vehicle speed of the vehicle reaches the set vehicle speed, when the vehicle climbes over the target object.

2. The driving support apparatus according to claim 1, wherein the hardware processor is configured to calculate the reduction amount being larger as the distance is shorter.

3. The driving support apparatus according to claim 1, wherein the hardware processor is configured to:
calculate an increase rate of the driving force from the initial driving force in accordance with a vehicle speed of the vehicle when reaching the target object; and
control the collision avoidance control so as to gradually increase the driving force from the initial driving force at the increase rate until the vehicle speed of the vehicle reaches the set vehicle speed, when the vehicle climbes over the target object.

4. The driving support apparatus according to claim 3, wherein the hardware processor is configured to calculate the increase rate being lower as the vehicle speed of the vehicle when reaching the target object is higher.

5. The driving support apparatus according to claim 1, wherein the hardware processor is configured to calculate the reduction amount in accordance with the distance and a gradient ratio of a road surface on which the vehicle travels to the obstacle.

6. The driving support apparatus according to claim 5, wherein the hardware processor is configured to calculate the reduction amount being larger as the distance is shorter and being smaller as the gradient ratio is larger.

7. A driving support method comprising:
detecting an obstacle in a travel direction of a vehicle;
controlling a driving force of the vehicle to perform collision avoidance control for the obstacle when the obstacle is detected;
calculating a reduction amount of the driving force when the vehicle has climbed over a target object present between the vehicle on which the collision avoidance control has been started and the obstacle, in accordance with a distance between the vehicle and the obstacle, when the vehicle has climbed over the target object; and
controlling the collision avoidance control so as to gradually increase the driving force from an initial driving force being a driving force smaller than required driving force determined from an accelerator position of an accelerator pedal operated by a driver until a vehicle speed of the vehicle reaches a set vehicle speed, and so as to reduce the driving force by the reduction amount when the vehicle speed of the vehicle reaches the set vehicle speed, when the vehicle climbes over the target object.

8. A non-transitory computer-readable medium on which an executable program is recorded, the program instructing a computer to carry out:
detecting an obstacle in a travel direction of a vehicle;
controlling a driving force of the vehicle to perform collision avoidance control for the obstacle when the obstacle is detected;
calculating a reduction amount of the driving force when the vehicle has climbed over a target object present between the vehicle on which the collision avoidance control has been started and the obstacle, in accordance with a distance between the vehicle and the obstacle, when the vehicle has climbed over the target object; and
controlling the collision avoidance control so as to gradually increase the driving force from an initial driving force being a driving force smaller than required driving force determined from an accelerator position of an accelerator pedal operated by a driver until a vehicle speed of the vehicle reaches a set vehicle speed, and so as to reduce the driving force by the reduction amount when the vehicle speed of the vehicle reaches the set vehicle speed, when the vehicle climbes over the target object.
